(19) United States
(12) Patent Application Publication
(10) Pub. No.: US 2022/0055587 A1
(43) Pub. Date: Feb. 24, 2022

(54) Control Architecture for Electrified Braking and Electrified Steering of a Vehicle

(71) Applicant: KNORR-BREMSE SYSTEME FÜR NUTZFAHRZEUGE GMBH, München (DE)

(72) Inventors: Tamas RAPP, Budapest (HU); Huba NEMETH, Budapest (HU); Csaba KOKREHEL, Budapest (HU)

(21) Appl. No.: 17/277,182

(22) PCT Filed: Sep. 3, 2019
(86) PCT No.: PCT/EP2019/073486

§ 371 Date: Mar. 17, 2021

(30) Foreign Application Priority Data
Sep. 18, 2018 (EP) 18195300.1

(51) Int. Cl. B60T 8/88; B62D 9/00; B60W 50/029; B60W 10/20; B60W 10/18

(52) U.S. Cl. CPC B60T 8/885; B62D 9/005; B60W 50/029; B60W 10/20; B60W 2050/0292; B60T 2260/02; B60T 2270/402; B60T 2270/413; B60T 2270/414; B60W 10/18

(57) ABSTRACT

A control architecture for electrified braking and electrified steering of a vehicle supplies a steering actuator and a steering controller with power from a first one of at least two energy supply units. Two brake actuators are supplied with power from a second one of the at least two energy supply units. A first brake actuator is associated with a first wheel of the vehicle and a second brake actuator is associated with a second wheel of the vehicle. The first brake actuator and/or the second brake actuator is/are actuated to perform a steering function for the vehicle.

### FIELD OF THE INVENTION

The present invention relates to a control architecture for electrified braking and electrified steering of a vehicle, and a control method for a control architecture for electrified braking and electrified steering of a vehicle.

### BACKGROUND OF THE INVENTION

Today the control and/or actuation of many safety relevant systems (e.g. brake system, etc.) of commercial vehicles utilizes compressed air as a power supply. The redundancy of certain systems is required (e.g. brake system) both for control and also for power supply. Electrification of such vehicles is in progress, and as such requires a redesign of some vehicle system architecture and components. Due to electrification, many pneumatic units are going to be replaced by electrically controlled and/or powered ones. Beside electrification, AD (Automated Driving) applications also set new requirements for vehicle systems, especially for safety relevant units. These applications make necessary the provision of redundant systems, especially where the fall-back performance cannot be provided by a human driver.

DE 10 2006 010 713 A1 describes an electrical system for a vehicle with at least one safety-relevant load, which is provided with a primary system and a secondary system of the on-board electrical system.

However, there is a need to provide a means for braking and steering redundancy.

Therefore, it would be advantageous to have an improved technology to provide for braking and steering redundancy.

### SUMMARY OF THE INVENTION

The need is met with the subject matter of the independent claims, wherein further embodiments are incorporated in the dependent claims. It should be noted that the following described aspects of the invention apply also for the control architecture for electrified braking and electrified steering of a vehicle and the control method for a control architecture for electrified braking and electrified steering of a vehicle.

In a first aspect, there is provided a control architecture for electrified braking and electrified steering of a vehicle, the control architecture comprising:

at least two energy supply units;

a steering actuator;

a steering controller; and

two brake actuator units.

The steering actuator and steering controller are configured to be supplied with power from a first one of the at least two energy supply units. The two brake actuators are configured to be supplied with power from a second one of the at least two energy supply units. A first brake actuator is associated with a first wheel of the vehicle and a second brake actuator is associated with a second wheel of the vehicle. Actuation of the first brake actuator and/or the second brake actuator is configured to perform a steering function for the vehicle.

In this manner, an electric control and power supply architecture is provided for brake and steering system redundancy, where control and power supplies for electrified brake and steering actuators are connected in a way that enables the brake system to be used as a backup for the steering.

In other words, if normal steering functionality fails, through the power supply for steering and/or the steering actuator or steering controller failing or malfunctioning, emergency steering functionality can be provided through the application of brakes to one wheel or two wheels using differential braking, via a separately powered braking system.

In an example, the first brake actuator and second brake actuator are associated with the two wheels of a same axle of the vehicle.

In an example, the first brake actuator and/or second brake actuator are configured to perform the steering function for the vehicle upon detection of a failure or malfunction in one of more of: the first one of the energy supply units; the steering actuator; and the steering controller.

In an example, the control architecture comprises at least one brake control unit. A first brake control unit of the at least one brake control unit is supplied with power from the second of the at least two energy supply units.

In an example, the first brake control unit is configured to control actuation of the first brake actuator and/or the second brake actuator to perform the steering function.

In a second aspect, there is provided a control method for a control architecture for electrified braking and electrified steering of a vehicle, the method comprising:

a) supplying a steering actuator and a steering controller with power from a first one of at least two energy supply units;
b) supplying two brake actuators with power from a second one of the at least two energy supply units, wherein a first brake actuator is associated with a first wheel of the vehicle and a second brake actuator is associated with a second wheel of the vehicle; and
d) actuating the first brake actuator and/or the second brake actuator to perform a steering function for the vehicle.

In an example, the first brake actuator and second brake actuator are associated with the two wheels of a same axle of the vehicle.

In an example, the method comprises step c), detecting a failure or malfunction in one of more of: the first one of the energy supply units; the steering actuator; and the steering controller, and wherein step d) is performed after a failure or malfunction has been detected.

In an example, step b) comprises supplying a first brake control unit of at least one brake control unit with power from the second of the at least two energy supply units.

In an example, in step d), the first brake control unit controls actuation of the first brake actuator and/or the second brake actuator to perform the steering function.

The above aspects and examples will become apparent from and be elucidated with reference to the embodiments described hereinafter.

Exemplary embodiments will be described in the following with reference to the following drawings.

### BRIEF DESCRIPTION OF THE DRAWINGS

FIG. 1 is a schematic representation of an example of a control architecture for electrified braking and electrified steering of a vehicle;

FIG. 2 shows a control method for a control architecture for electrified braking and electrified steering of a vehicle; and

FIG. 3 shows a redundancy architecture for electrified brake and steering actuators.

### DETAILED DESCRIPTION OF EMBODIMENTS

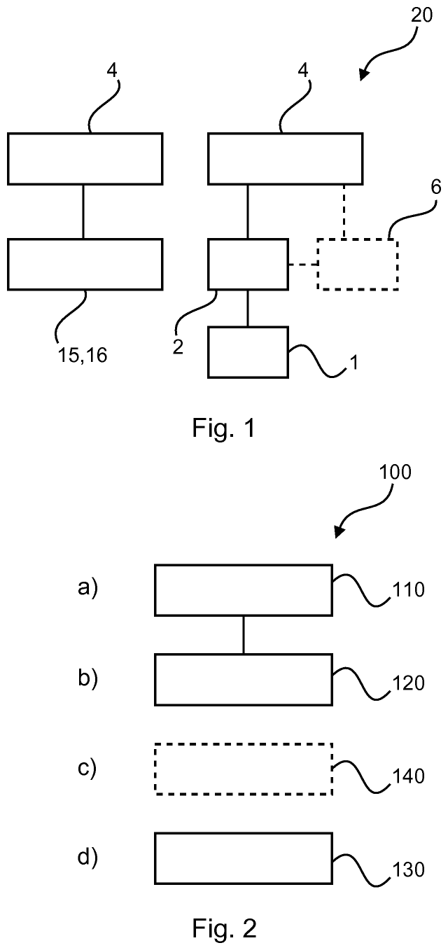

FIG. 1 shows an example of a control architecture 20 for electrified braking and electrified steering of a vehicle. The control architecture 20 comprises at least two energy supply units 4, a steering actuator 15, a steering controller 16, and two brake actuator units 2. The steering actuator and steering controller are configured to be supplied with power from a first one of the at least two energy supply units. The two brake actuators are configured to be supplied with power from a second one of the at least two energy supply units. A first brake actuator is associated with a first wheel 1 of the vehicle and a second brake actuator is associated with a second wheel of the vehicle 1. Actuation of the first brake actuator and/or the second brake actuator is configured to perform a steering function for the vehicle.

According to an example, the first brake actuator and second brake actuator are associated with the two wheels of a same axle of the vehicle.

According to an example, the first brake actuator and/or second brake actuator are configured to perform the steering function for the vehicle upon detection of a failure or malfunction in one of more of: the first one of the energy supply units; the steering actuator; and the steering controller.

According to an example, the control architecture comprises at least one brake control unit 6. A first brake control unit of the at least one brake control unit is supplied with power from the second of the at least two energy supply units.

According to an example, the first brake control unit is configured to control actuation of the first brake actuator and/or the second brake actuator to perform the steering function.

FIG. 2 shows a control method 100 for a control architecture for electrified braking and electrified steering of a vehicle in its basic steps, where optional steps are shown dashed. The method 100 comprising:

in a supplying step 110, also referred to as step a), supplying a steering actuator 15 and a steering controller 16 with power from a first one of at least two energy supply units 4;

in a supplying step 120, also referred to as step b), supplying two brake actuators 2 with power from a second one of the at least two energy supply units, wherein a first brake actuator is associated with a first wheel of the vehicle and a second brake actuator is associated with a second wheel of the vehicle; and in an actuating step 130, also referred to as step d), actuating the first brake actuator and/or the second brake actuator to perform a steering function for the vehicle.

According to an example, the first brake actuator and second brake actuator are associated with the two wheels of a same axle of the vehicle.

According to an example, the method comprises step c), detecting 140 a failure or malfunction in one of more of: the first one of the energy supply units; the steering actuator; and the steering controller, and wherein step d) is performed after a failure or malfunction has been detected.

According to an example, the control architecture comprises at least one brake control unit 6, and wherein step b) comprises supplying a first brake control unit of the at least one brake control unit with power from the second of the at least two energy supply units.

According to an example, in step d), the first brake control unit controls actuation of the first brake actuator and/or the second brake actuator to perform the steering function.

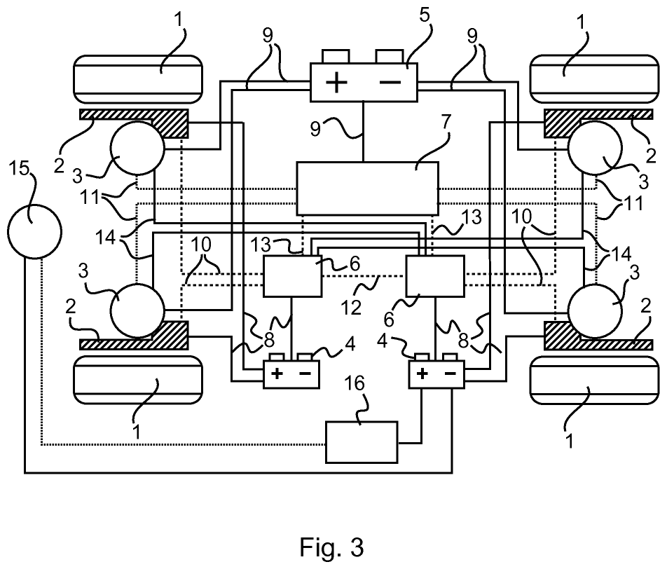

FIG. 3 shows a detailed example of a redundancy architecture for electrified brake and steering actuators. The architecture includes a redundant electric energy supply with at least two energy storages 4, and at least two vehicle dynamic control ECUs or brake control units 6. The steering is electrically controlled and actuated with a steering actuator 15 and a steering controller 16. The system uses electrified wheel brakes(s) supplied and controlled axle wise from the energy storages or energy storage units in the form of batteries 4 and the ECUs 6. In case of the system functioning without a malfunction, the steering function is carried out by the steering gear or actuator 15. However, in the situation when there has been a malfunction of the steering components 15 and 16, the steering function can be taken over by the brake actuators 2 using a differential braking. For this steer-by-brake function, a positive steering roll radius can be required. Therefore, in order that in the situation where the power supply or the vehicle dynamic ECU to which the steering components 15 and 16 are connected fail, the brake actuators that take over the steering function are supplied and commanded from another redundant circuit separate to that used for normal steering. Thus, in summary steering and braking redundancy is provided through the control and the power supply for the steering actuator being connected to a different circuit than the brake actuators of the steered axle.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope.

### LIST OF REFERENCE NUMBERS

1—wheel
2—brake actuator unit
3—propulsion actuator unit
4—energy supply unit brake system
5—energy supply unit drive system
6—brake control unit
7—propulsion control unit
8—energy supply line brake system
9—energy supply line drive system
10—communication/control line brake system
11—communication/control line propulsion system
12—communication/control line between brake control units
13—communication/control line between brake and propulsion control units
14—communication/control line between brake and propulsion actuator units
15—steering actuator
16—steering controller
20—A control architecture for electrified braking and electrified steering of a vehicle;
100—A control method for a control architecture for electrified braking and electrified steering of a vehicle;
110—supplying a steering actuator and a steering controller with power from a first one of at least two energy supply units;
120—supplying two brake actuators with power from a second one of the at least two energy supply units; and
130—actuating the first brake actuator and/or the second brake actuator to perform a steering function for the vehicle.

1.-10. (canceled)

11. A control architecture for electrified braking and electrified steering of a vehicle, the control architecture comprising:
at least two energy supply units;
a steering actuator;
a steering controller; and
two brake actuator units;
wherein the steering actuator and steering controller are configured to be supplied with power from a first one of the at least two energy supply units,
wherein the two brake actuators are configured to be supplied with power from a second one of the at least two energy supply units,
wherein a first brake actuator is associated with a first wheel of the vehicle and a second brake actuator is associated with a second wheel of the vehicle, and
wherein actuation of the first brake actuator and/or the second brake actuator is configured to perform a steering function for the vehicle.

12. The control architecture according to claim 11, wherein
the first brake actuator and second brake actuator are associated with the two wheels of a same axle of the vehicle.

13. The control architecture according to claim 11, wherein
the first brake actuator and/or second brake actuator are configured to perform the steering function for the vehicle upon detection of a failure or malfunction in one of more of:
the first one of the energy supply units,
the steering actuator, or
the steering controller.

14. The control architecture according to 11, further comprising:
at least one brake control unit, wherein
a first brake control unit of the at least one brake control unit is supplied with power from the second of the at least two energy supply units.

15. The control architecture according to claim 14, wherein
the first brake control unit is configured to control actuation of the first brake actuator and/or the second brake actuator to perform the steering function.

16. A control method for a control architecture for electrified braking and electrified steering of a vehicle, the method comprising:
supplying a steering actuator and a steering controller with power from a first one of at least two energy supply units;
supplying two brake actuators with power from a second one of the at least two energy supply units, wherein a first brake actuator is associated with a first wheel of the vehicle and a second brake actuator is associated with a second wheel of the vehicle; and
actuating the first brake actuator and/or the second brake actuator to perform a steering function for the vehicle.

17. The method according to claim 16, wherein
the first brake actuator and second brake actuator are associated with the two wheels of a same axle of the vehicle.

18. The method according to any claim 16, further comprising:
detecting a failure or malfunction in one of more of:
the first one of the energy supply units;
the steering actuator; or
the steering controller, and wherein
the actuating of the first brake actuator and/or the second brake actuator to perform a steering function for the vehicle is performed after a failure or malfunction has been detected.

19. The method according to claim 16, wherein
the control architecture comprises at least one brake control unit, wherein
the step of supplying two brake actuators with power from a second one of the at least two energy supply units, wherein a first brake actuator is associated with a first wheel of the vehicle and a second brake actuator is associated with a second wheel of the vehicle, comprises supplying a first brake control unit of the at least one brake control unit with power from the second of the at least two energy supply units.

20. The method according to claim 19, wherein
the first brake control unit controls actuation of the first brake actuator and/or the second brake actuator to perform the steering function.
